(19) United States
(12) Patent Application Publication
(10) Pub. No.: US 2003/0011697 A1
(43) Pub. Date: Jan. 16, 2003

(54) Image pick up device and camera provided therewith

(76) Inventors: Jan Theodoor Jozef Bosiers, Eindhoven (NL); Yvonne Astrid Boersma, Nijmegen (NL)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(21) Appl. No.: 10/170,935

(22) Filed: Jun. 13, 2002

(30) Foreign Application Priority Data
Jun. 15, 2001 (EP) 01202307.3

(51) Int. Cl. H04N 5/335; H04N 3/14

(52) U.S. Cl. 348/317; 348/345

(57) ABSTRACT

The present invention relates to an image pick up device (11), comprising:

an image section (12) with a number of picture elements (pixels) arranged in rows and columns;

a storage section (13) with image storage elements arranged in rows and columns for (temporarily) at least partially storing an image recorded by the pixels, wherein the charge from the picture elements is transferred to the storage elements; and

a transition section (34, 35) screened from incident light between the image section (12) and the storage section (13), wherein one or more gates in or near the transition section (34, 35) have a length greater than the gates of the image section and/or the storage section.

The present invention relates to an image pick up device and to a camera provided therewith. Solid-state image pick up devices usually make use of the principle of Charged Coupled Devices (CCDs), wherein an array of gate electrodes is arranged on a layer of insulating material on a semiconductor substrate.

An electronic image-sensitive device comprising an interline-transfer CCD (IL-CCD) suitable for both motion and still images is known from, for example, U.S.A. 5,440,343.

WO-A-99 62245 relates to a frame transfer CCD (FT-CCD), which is also suitable for motion and still images. Situated herein between a matrix of pixels and one or more so-called horizontal output registers is an section of so-called vertical storage cells in which, for example, predetermined lines of an image can be stored.

A higher resolution is required for a still image of high quality than for picking up and recording moving television images. An image with lower resolution may also suffice for a still image in, for example, the viewfinder of a camera. Both above and below the lines of the image section there are usually a number of lines with dummy pixels, while black reference lines are situated adjacent thereto.

The dummy pixels prevent charge running over into the lines for black reference in the case of blooming, particularly in devices with pixels of small dimensions, which are particularly suitable for consumer applications. It is an object of the invention to provide a versatile pick up device and camera.

The present invention provides an image pick up device, comprising:

an image section with a number of picture elements (pixels) arranged in rows and columns;

a storage section with image storage elements arranged in rows and columns for (temporarily) at least partially storing an image recorded by the pixels, wherein the charge from the picture elements is transferred to the storage elements; and

a transition section screened from incident light between the image section and the storage section, wherein one or more gates in or near the transition section have a length greater than the gates of the image section and/or the storage section.

The maximum number of lines which a pixel can bloom in the case of overexposure during automatic testing of CCDs at a predetermined overexposure is in practice set at the factory such that the black reference line remains empty. This means in practice that blooming can occur over a maximum of two lines. In the case of small pixels such as those used in video cameras for consumer applications, blooming does not represent a problem. The relatively low maximum charge storage of the small pixel is thereby increased. According to the present invention, several lines between the edge of the light screen and the black line are made longer. The longer gates, for example 5-100% longer, ensure that the lateral barrier from line to line remains greater than the barrier to the substrate, whereby it remains possible to allow a certain degree of blooming in a pixel as well as to retain a good black reference.

The length of successive gates is preferably increased gradually in stepwise manner up to the black reference line and then gradually decreased again in stepwise manner away from the black line reference, for instance with steps of 10-30%, preferably about 20%. This prevents the charge storage being reduced in transport direction by two-dimensional potential effects. A longer gate, however, acting as an integrating gate will be able to contain more charge.

In a further preferred embodiment, the length of a normal gate amounts to 0.9 μm and the lengths of lengthened gates to about 1.2, 1.3 and 1.5 μm.

Further features, details and advantages of the present invention will be elucidated on the basis of the following description of a preferred embodiment thereof with reference to the annexed drawings, in which:

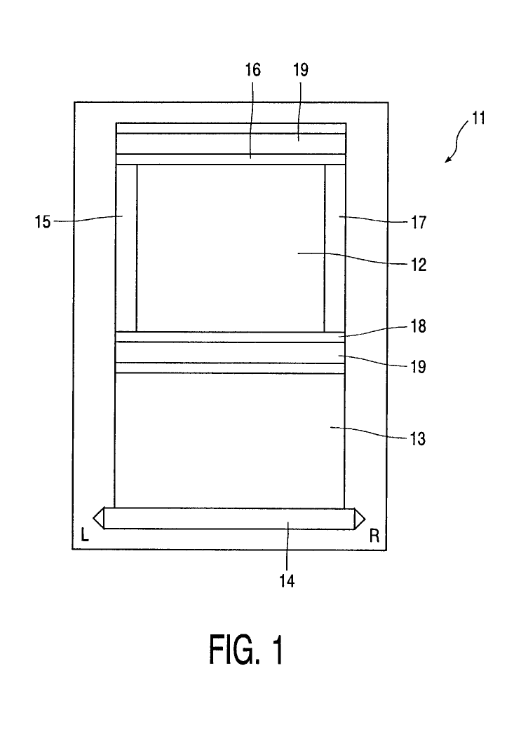

FIG. 1 is a diagrammatic view of a first preferred embodiment of the image recording device according to the present invention;

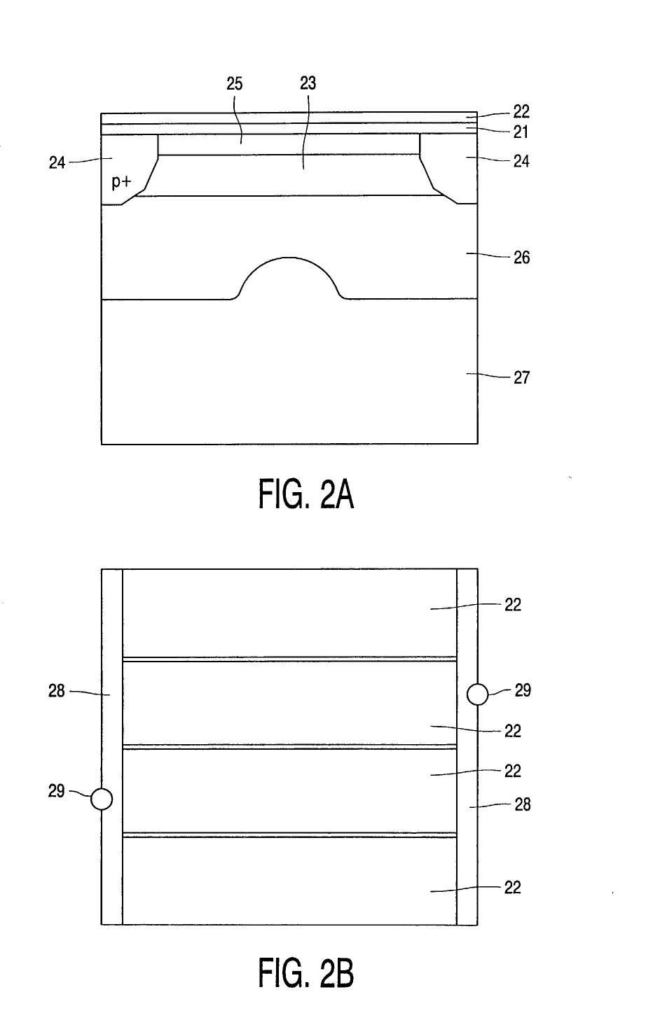

FIG. 2 shows an embodiment of a picture element which can be applied in the image recording device of FIG. 1;

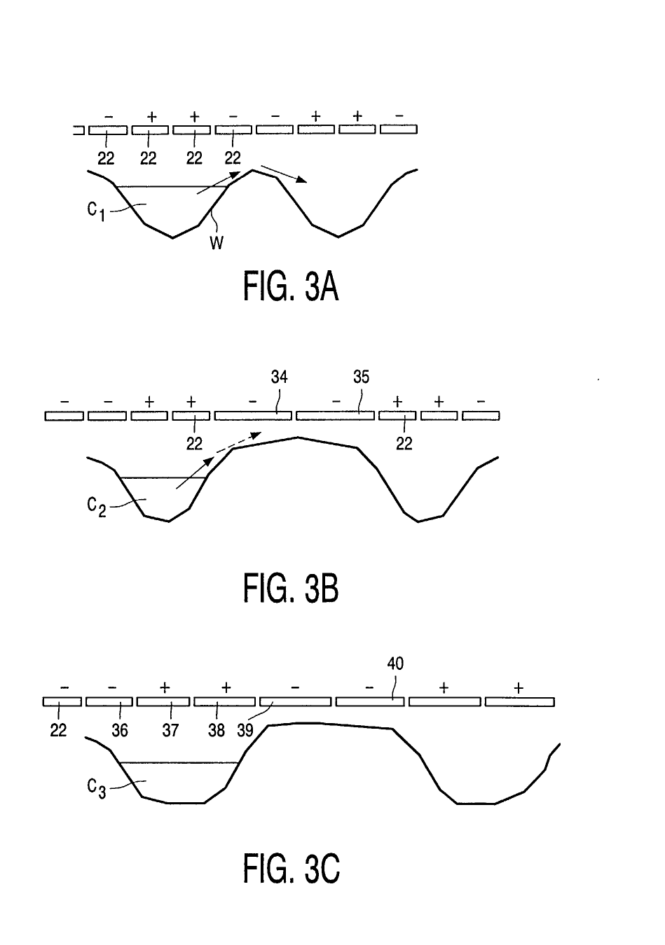

FIGS. 3A, 3B and 3C are diagrammatic views elucidating the application of longer gates in the devices shown in FIG. 1 and FIG. 2; and

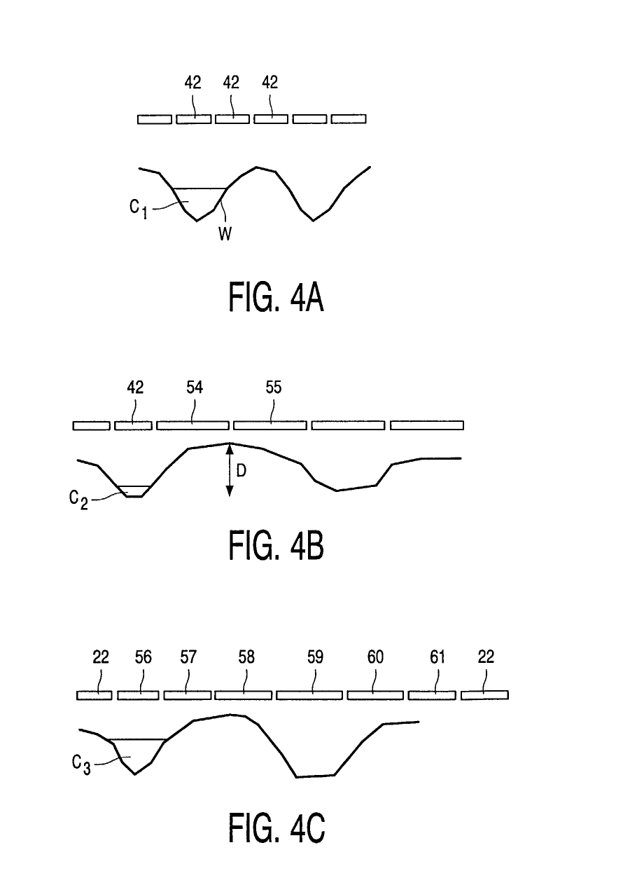

FIGS. 4A, 4B and 4C are diagrammatic views of the application of longer gates in a three-phase pixel system.

A preferred embodiment of an image pick up or recording device 11 (FIG. 1) comprises an image section in which in known manner R, G and B (red, green and blue) picture elements (pixels) are present which are photosensitive and which are provided with a gate structure which enables transport of the generated charge carriers to a storage section 13 from which the charge carriers generated by the light are drained for further processing by a so-called horizontal register 14.

An example is an image recording device with an image section comprising 1280 lines of 960 pixels each. The dimensions of each pixel are, for example, 3.7 by 3.7 μm². For the transfer of the charge carriers from the image section, which in the present embodiment comprises, for example, 240 lines, to the storage section, use is made of the so-called charge coupling principle wherein the generated charge is transported by a number of gates arranged on an oxide layer on a semiconductor substrate. The charge carriers are here captured in a (visual) well which is displaced by changed charges on the gates.

When exposure is excessive, a number of charge carriers can pass over a potential barrier into a subsequent well, whereby blooming occurs. A smearing of the overexposure can result from this, which is permissible per se, and in some respects even advantageous for consumer applications.

The image section is provided with light screens 15, 16, 17 and 18 on its edges. Below the light screens 16 and 18 there are one or more black reference lines 19 which are to provide an accurate reference of a black level for a correct operation of the video camera provided with the present pick up device. It is therefore undesirable for charge carriers to be able to make their way into this black line owing to the blooming effect mentioned above.

In the example of a four-phase pixel as shown in FIGS. 2A and 2B, further details of which are described in the article by H. Peek et al. ‘An FT-CCD image with true 2.4×2.4 μm² pixels in double membrane poly-Si technology’ (IEDM 1996 pp. 35.3.1-4), four gates with a length of 0.9 μm of polysilicon 22 are situated in each case on an insulating layer 21 if side, while an N-channel 23 extends between two stop regions 24. A so-called profiled peristaltic implant for enlarging the well, i.e. the charge capacity, is situated between the oxide layer and the N-channel, while a P-well 26 is situated on the N-substrate 27 under the gate 23.

The top view of FIG. 2B also shows the metal contact strips 28 and continuous contacts 29 which drive the gates 22 of a cell.

As shown in FIG. 3A, charge carriers C₁ can be situated in a potential well W under a gate 22 having a standardized length, for example, 0.9 μm. According to the present invention and in contrast to what is shown in FIG. 3A, a number of gates situated close to the black line 18 between the image section 12 and the storage section 13 are lengthened, such as gates 34 and 35 in FIG. 3B, so that charge carriers C₂ can pass less easily over the potential barrier D into the black line. With too abrupt a lengthening of the gate the charge storage under an adjacent gate is reduced because of two-dimensional potential effects, see, for example, charge C₂ in FIG. 3B.

According to the preferred embodiment of FIG. 3C, however, the gates 36, 37, 38, 39 and 40 are gradually lengthened in stepwise manner in order to substantially prevent the charge storage in an adjacent potential well which is also adversely affected by a blocking gate. Although the gates can be lengthened in steps of 5-100% at a time, the preferred embodiment shows steps of 10 to 30%, or about 20%, for example a sequence of 1.1, 1.3, and 1.5 μm, after which the gates are again shortened in the same manner.

The lengthening (and shortening) of gates may also be applied to two-phase or three-phase CCD structures. In the three-phase structure of FIGS. 4A, 4B and 4C, the gates of standard length have reference numerals 42. The references C₁, C₂, C₃, W and D are equivalent to the above references in relation to FIGS. 3A to 3C. The lengthened gates 54 and 55 in FIG. 4B correspond to the lengthened gates 34 and 35 in FIG. 3B. The lengthened gates 56, 57, 58, 59 and 60 correspond to gates 36 to 40 of FIG. 3C.

The application is not limited to the above described preferred embodiment; the rights sought are rather defined by the following claims, within the scope of which many modifications can be envisaged.

A non-limiting modification relates to a hole CCD with a PNP structure instead of the embodiment described above wherein a CCD collects and transfers electrons in a vertical NPN structure.

1. Image pick up device (11), comprising:
an image section (12) with a number of picture elements (pixels) arranged in rows and columns;
a storage section (13) with image storage elements arranged in rows and columns for (temporarily) at least partially storing an image recorded by the pixels, wherein the charge from the picture elements is transferred to the storage elements; and
a transition section (34, 35) screened from incident light between the image section (12) and the storage section (13), wherein one or more gates in or near the transition section (34, 35) have a length greater than the length of the gates of the image section (12) and/or the storage section (13).

2. An image recording device as claimed in claim 1, wherein the image section (12) comprises 1280 lines of 960 pixels each, and the dimensions of a pixel are 3.7 by 3.7 μm² .

3. An image recording device as claimed in claim 1 or 2, wherein the storage section (13) comprises 240 lines of 960 pixels each.

4. An image recording device as claimed in claim 1 or 2, wherein the gates are lengthened gradually in a stepwise manner in the transport direction of the charge carriers and then shortened beyond a black reference line.

5. An image recording device as claimed in the claims 1, 2, 3 or 4, wherein the gates are lengthened (and shortened) in steps of 5 to 100%, preferably 10 to 30% at a time.

6. An image recording device as claimed in claim 5, wherein the gates are lengthened and shortened in steps of about 20%.

7. An image recording device as claimed in the claims 1, 2, 3, 4, 5 or 6, wherein the lengths of the gates are successively about 0.9 μm, about 1.1 μm, about 1.3 μm, and about 1.5 μm.

8. A camera provided with an image recording device as claimed in any one of the foregoing claims.

9. A camera as claimed in claim 8, having a three-phase CCD system.

10. A camera as claimed in claim 8, having a four-phase CCD system.
